(19) United States
(12) Patent Application Publication
(10) Pub. No.: US 2005/0076128 A1
(43) Pub. Date: Apr. 7, 2005

(54) Method to allow voice, video and data conference with minimum bandwidth consumption between two or more geological locations and achieve quality of service (QoS) and scalability

(76) Inventor: Mingtar Tsai, Cupertino, CA (US)

Correspondence Address: Mingtar Tsai, 19925 Stevens Creek Blvd., Cupertino, CA, 95014, US

(21) Appl. No.: 10/945,614

(22) Filed: Sep. 21, 2004

Related U.S. Application Data
(60) Provisional application No. 60/505,042, filed on Sep. 24, 2003.

(51) Int. Cl. G06F 15/16

(52) U.S. Cl. 709/227

(57) ABSTRACT

A system and method to allow voice, video and data conference with minimum bandwidth consumption with endpoints in two or more geological locations. The system includes signal server to manage one or multiple media servers. The method supports transmission of only one data stream between two media servers while each media server can support multiple endpoints. The method can achieve voice/video/data quality of service (QoS) and scalability. The servers and endpoints send/receive commands and data using TCP, UDP or any proprietary protocol, depending on server's configuration and protocol requirements. This method is compatible with existing communication standards, such as H.323, SIP, MGCP, MEGACO, and T.120.

### CROSS-REFERENCE TO RELATED APPLICATION

This application claims the priority benefit of a provisional application Ser. No. 60/505,042, filed Sep. 24, 2003, titled “Method to allow voice, video and data conference with minimum bandwidth consumption between two or more geological locations and achieve quality of service (QoS) and scalability”. All disclosures are incorporated herewith.

### BACKGROUND OF THE INVENTION

1. Field of the Invention

This invention relates to voice, video and data conference between two or more geological locations with minimum bandwidth consumption and achieves quality of service and scalability through Intranet or Internet.

2. Description of Related Art

Voice, video and data conference over IP is one of the most important Internet/Intranet applications. The conference server includes signal server and media server (Reference FIG. 1). When endpoint 70 sends data to the conference server 60 (Reference FIG. 2), the conference server needs to send data to all other endpoints except endpoint 70. If the endpoints are in two or more geological locations, it will consume large amount of bandwidth by sending data to these end points directly. This can cause transmission time delay and quality issues for voice/video/data conference. For example, a conference has 20 endpoints grouped in 2 geological remote locations with 10 endpoints in each location. When the media server receives data from one endpoint, the media server needs to send the same data to the other nineteen endpoints with 10 endpoints' data traversing slow WAN connection. To solve this problem, two or more media servers are deployed at each remote locations and one signal control server at a neutral location to manage all of the media servers. The signal control server can use, but not limited to standard protocols, such as SIP/H323/MGCP/MEGACO. This method can also use proprietary protocol.

At each geological location, at least one media server is deployed. Endpoints will send their voice/video/data to the nearest (shortest distance or least transmission delay) media server. All media servers are inter-connected using public Internet or dedicated, reliable high-speed communication link, such as T1/T3/ATM/Frame Relay. No matter how many endpoints are at one location, the media server will send only one data stream to the other corresponding media server. This way, consumption of Internet/Intranet bandwidth will be greatly reduced and quality of service (QoS) is guaranteed.

### SUMMARY OF THE INVENTION

The present invention provides a signal control server and one or multiple media servers, through which endpoints at two or more geological locations can communicate with each other using the Internet or Intranet.

The present invention supports only one data stream transmission between two-media servers, with each media server supporting as many endpoints as each media server allows.

The present invention will reduce bandwidth consumption during conference by using geologically dispersed media servers. The present invention supports communication links between media servers using public Internet or dedicated high-speed connections.

The present invention will guarantee the quality of service (QoS) for voice/video/data conference.

The present invention supports media server that controls two or more endpoints.

The present invention supports one signal server that manages two or more media servers.

The present invention supports endpoints located at different geological locations.

The present invention supports endpoints using TCP or UDP to transmit command and data to signal and media servers. The present invention supports transmission of multimedia commands and data for voice, video, and regular data.

The present invention supports all of the existing multimedia communication protocols, such as H.323 (a standard approved by the International Telecommunication Union, reference ITU-T H.323), session initiation protocol (SIP, reference IETF RFC 2543), media gateway control protocol (MGCP, reference IETF RFC 2705), and media gateway control (MEGACO, reference ITU-T H.248), T.120 (Reference ITU-T 120) and proprietary protocol.

The present invention supports scalability to more than one thousand endpoints per conference session by using multiple media servers.

### BRIEF DESCRIPTION OF THE DRAWINGS

These, as well as the other features of the present invention, will become apparent upon reference to the drawings wherein:

FIG. 1 is a block diagram depicting media servers 30, 40 and 50 sending registration commands to the signal server. The conference server includes signal server and media server.

FIG. 2 is a block diagram depicting endpoints 70, 80 and 90 sending registration commands to the signal server.

FIG. 3 is a block diagram depicting endpoint 70 sending a command to the signal server 60 to join the conference session. The signal server in turn sends a command to media server 30 to set up a conference session for endpoint 70.

FIG. 4 is a block diagram depicting the media server 30 sending the response back to the signal server 60 and the signal server 60 in turns sending the response back to endpoint 70 for acknowledgement of setting up the requested conference session.

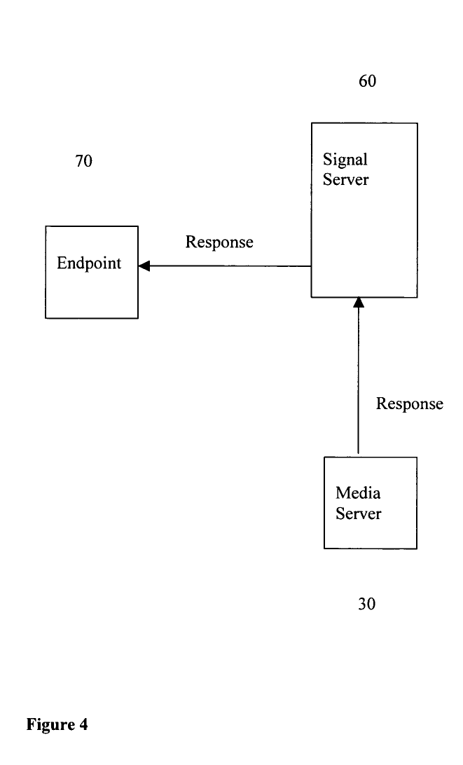

FIG. 5 is a block diagram depicting how the signal server 60, for example, using SIP protocol, creates a virtual endpoint and connection between media server 30 and media server 40. First, the signal server 60 sends a SIP INFO message to the media server 30. The SIP INFO message contains information of Media servers 30 and 40, such as media server ID, IP address, and conference session number. When media server 30 receives SIP INFO from signal server 60, Media server 30 will create a virtual endpoint and set up a communication port (TCP or UDP) for sending and receiving voice/video/data. Media server 30 sends the SIP INVITE message with virtual endpoint information, such as endpoint ID, IP address, and port number(s), to the Signal Server 60. The signal server 60 will send the INVITE message with information from media server 30 to media server 40. When media server 40 receives the INVITE message from the Signal Server 60, it will create a virtual endpoint and setup communication port (TCP or UDP) for voice/video/data sending and receiving. Media server 40 sends the SIP RESPONSE message with information, such as endpoint ID, IP address, and port number(s), to the Signal Server 60. The Signal Server 60 will send the SIP RESPONSE message to media server 30 from media server 40. Media server 30 and 40 can communicate to each other for sending and receiving voice/video/data.

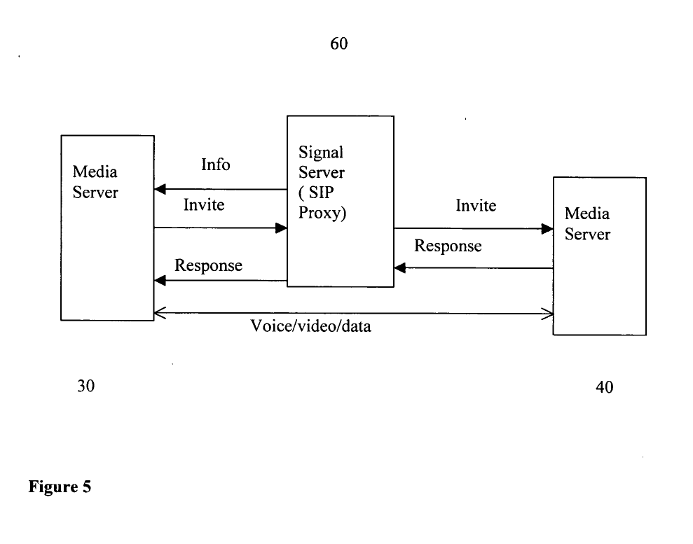

FIG. 6 is a block diagram depicting endpoint 70 sending voice/video/data to the remote endpoint 80 by sending data to the media server 30 first. Media server 30 will send data from endpoint 70 to the media server 40. Media server 40 then sends voice/video/data to Endpoint 80. Similarly, endpoint 80 sends data to endpoint 70 through media server 40 and media server 30.

FIG. 7 is a block diagram depicting how multiple remote endpoints send and receive voice/video/data from each other. Endpoint 70 sends voice/video/data to endpoint 80 through media server 30 and media server 40, and vise versa.

Endpoint 70 sends voice/video/data to endpoint 90 through media server 30 and media server 50, and vise versa.

Endpoint 80 sends data to endpoint 90 through media server 40 and media server 50, and vise versa.

### DESCRIPTION OF THE PREFERRED EMBODIMEN

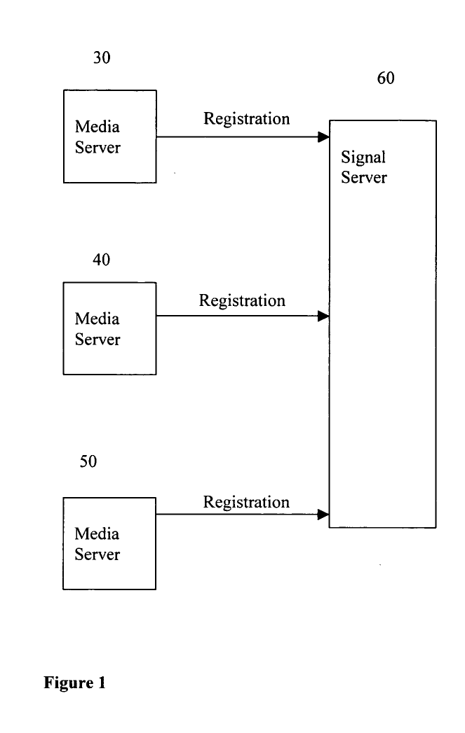

FIG. 1 depicts each media server registers with the signal server 60. During registration, each media server will send its local information, such as country code, Universal Time (UTC), or telephone country/area code to the signal server 60. The signal server 60 will save and keep track of this local information for each media server.

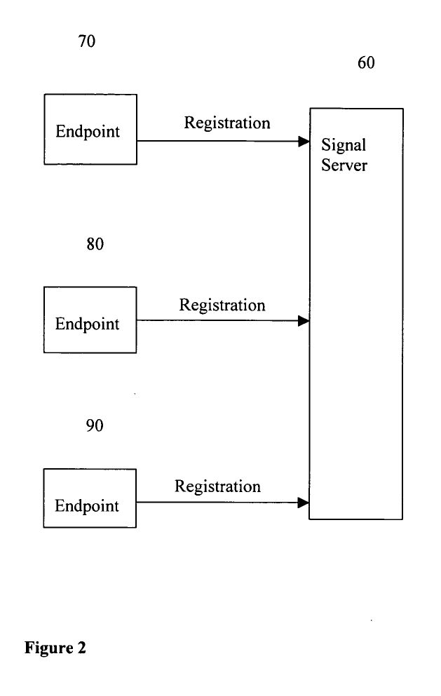

FIG. 2 depicts remote endpoints register with the signal server 60. During registration, each endpoint will send its local information, such as endpoint country code, Universal Time (UTC), telephone country/area code, or pre-assigned media server identification, to the signal server 60. Signal server 60 will use this local information to find the nearest (shortest distance or least delay time) media server for each endpoint.

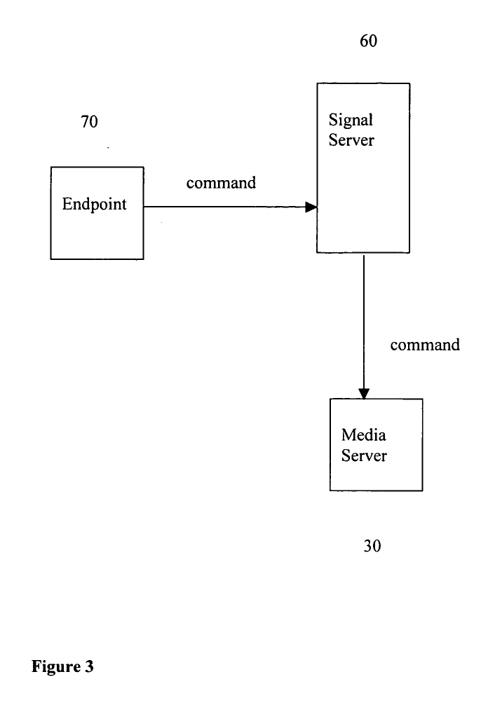

When endpoint 70 joining the conference session (FIG. 3), it first sends a signal command, such as SIP INVITE, to the signal server 60. The signal server 60 will determine which media server is nearest (shortest distance or least time delay) to endpoint 70, for example media server 30. The signal server 60 then sends a command to media server 30. Media server will in turn responds back to signal server 60 which in turn responds back to endpoint 70 with information about media server 30. When endpoint 80 joins the conference session, the same process as endpoint 70 applies.

Media server 30 and media server 40 could be the same or different servers. If media server 30 and media server 40 are two different servers, the signal server 60 will send command to media servers 30 and 40 respectively. Media servers 30 and 40 will create a virtual endpoint to communicate with each other. Using this method, signal commands (such as SIP INVITE, RESPONSE, or ACKNOLEDGE) can be exchanged between endpoints 70, 80, signal server 60, and media servers 30 and 40. Media servers 30 and 40 can be located at different geological locations. Because endpoint only communicates with the nearest media server, the communication transmission time will be the shortest. In order to provide quality of service (QoS) for endpoints 70 and 80, media servers 30 and media server 40 should be inter-connected using high speed dedicated link or public internet with low transmission time.

If media server 30 is fully loaded and at its capacity, signal server 60 can find next available media server 31 for the endpoint 90 trying to join the same multimedia session. Media server 31 will be the next nearest media server other than 30 to endpoint 90. Media server 30 and media server 31 can be physically located at the same location or different location. The signal server 60 as described in [240], will send commands to media servers 30 and 31. Media server 30 and 31 will create a virtual endpoint to communicate with each other.

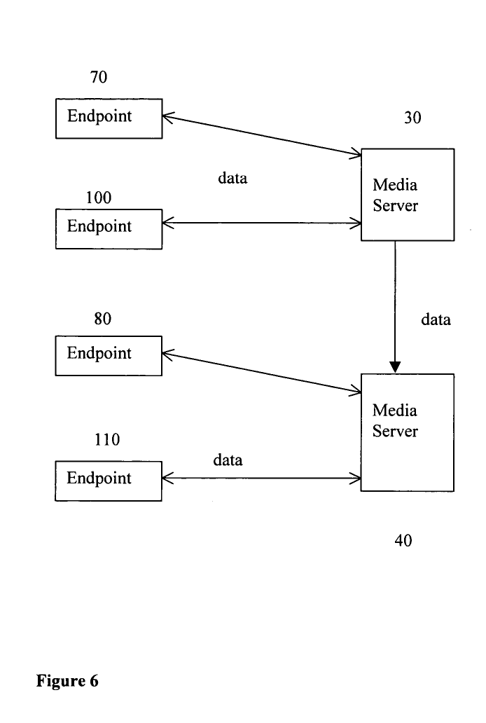

Communication between endpoints 70 and 80 will be as follows. Endpoint 70 sends voice/video/data to the nearest media server 30 (determined by signal server 60). Endpoint 80 will send voice/video/data to its nearest media server 40. To exchange information, Media server 30 will send the received voice/video/data from endpoint 70 to media server 40 and media server 40 will send the received voice/video/data from endpoint 80 to media server 30 (Reference FIG. 6).

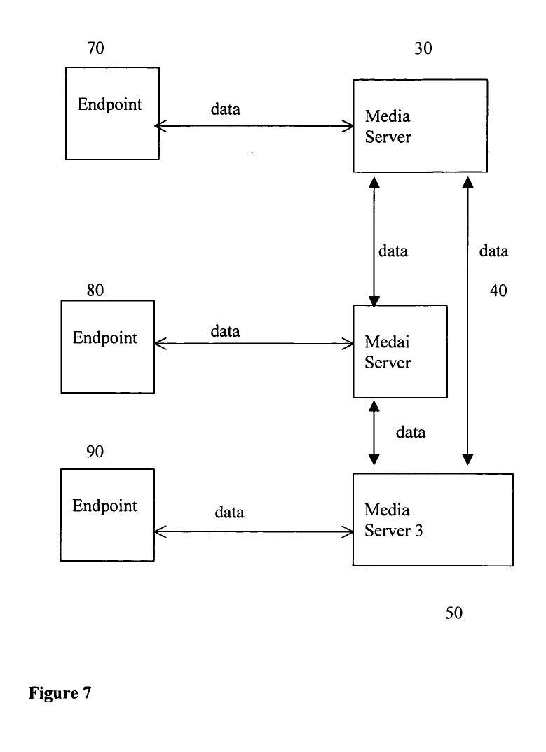

For every conference session, each media server sends/receives voice/video/data from two or more endpoints. In order minimize network transmission, each media server can perform data processing, for example, data conversion, compression/decompression and mixing/de-mixing of voice/video/data from multiple endpoints, and therefore, needs to send only one data stream to the other media server. For each conference session, there can be two or more media servers involved. All involved media servers will communicate with each other and send/receive only one data stream as needed (Reference FIG. 7).

Each media server can handle a predefined number of endpoints based on its hardware and network configuration. If the number of endpoints exceeds the predefined maximum number that the media server can support, the signal server will assign any new endpoints to the next nearest media server. The same logic applies when the new media server reaches its capacity. This way, the number of endpoints in each conference session is only limited by the number of media servers deployed and hence achieve extremely scalable operation.

For voice and video conference, existing communication standards, such as H.323, SIP, MGCP, or MEGACO can be used to setup a conference.

For data conference, existing communication standards, such as H.323, SIP, MGCP, or MEGACO can be used to setup a conference, and T.120 can be used as data transmission protocol.

1. A method to allow voice, video and data conference between two or more geological locations:
Media servers will register with the signal server.
Endpoints will register with the signal server.
The signal server will assign each endpoint with the nearest media server.
The media server will create one virtual endpoint to communicate with other media server.

2. A method according to claim 1, each media server can support two or more endpoints.

3. A method according to claim 1, only one data stream is transmitted between two-media servers with each media server supporting multiple endpoints in the same conference session.

4. A method according to claim 1, each conference session can scale to more than one thousand endpoints in one conference session.

5. A method according to claim 1, wherein server includes a signal server.

6. A method according to claim 1, wherein the signal server is a H.323 Gatekeeper.

7. A method according to claim 1, wherein the signal server is a session initiation protocol (SIP) Proxy server.

8. A method according to claim 1, wherein the signal server is a media gateway control protocol (MGCP) callagent server.

9. A method according to claim 1, wherein the signal server is media gateway control (MEGACO) callagent server.

10. A method according to claim 1, wherein the server further includes a media server.

11. A method according to claim 1, media server to media server communication consumes minimal bandwidth.

12. A method according to claim 1, supports two or more geological locations in one conference session.

13. A method according to claim 1, voice, video and data conference can achieve quality of service (QoS).

14. A method according to claim 1, supports all existing communication standards, such as H.323, SIP, MGCP, MEGACO, T.120 and any proprietary protocol.

15. A method according to claim 1, supports communication method using TCP or UDP or both.

16. A method according to claim 1, wherein the media server is a hardware or software-based telephony gateway.

17. A system for transmitting voice, video and data between two or more geological locations:
the system comprises:
a first transmission path, for the endpoint to send a first command to the signal control server using a first transmission protocol, wherein the signal server will save the endpoint information and assign the nearest media server therein,
a second transmission path, for the signal control server to send the command to the media server one and receiving a first response to the first command from the media server one, and
a multimedia data transmission path being established when the signal control server sending the first response to the first endpoint, thereby the multimedia data transmission path allow the transmission for multimedia data through the first endpoint and the first media server
a third transmission path, for the second endpoint to send a first command to the signal control server with a first transmission protocol, wherein the signal server will save the endpoint information and assign the nearest media server therein,
a fourth transmission path, for the signal control server to send the command to the media server two and receiving a first response to the first command from the media server two, and
a multimedia data transmission path being established when the signal control server sending the first response to the second endpoint, thereby the multimedia data transmission path allow the transmission for multimedia data through the second endpoint and the second media server,
The signal control server will send command to the media server one and media server two for creating one virtual endpoint in each media server to communicate with each other therein,
the first endpoint sends multimedia data to the first media server, the first media server sends the multimedia data to the second media server, the second media server sends the multimedia data to the second endpoint.

18. A method according to claim 17, each media server supports two or more endpoints.

19. A method according to claim 17, in the same conference session, only one data stream is transmitted between two-media servers which can support multiple endpoints and are only limited to the physical limitations.

20. A method according to claim 17, supports minimum bandwidth consumption between two or more servers for each conference session.

21. A method according to claim 17, supports two or more geological locations in one conference session.

22. A method according to claim 17, media server communicates with another media server, which can be in the same location or remote geological location.

23. A method according to claim 17, each conference session can support more than one thousand endpoints.

24. A method according to claim 17, the signal control server can assign endpoint to send multimedia data to the nearest media server.

25. A method according to claim 17, voice, video and data conference can achieve quality of service (QoS).

26. A method according to claim 17, supports all existing communication standards, such as H.323, SIP, MGCP, MEGACO, T.120 and any proprietary protocol.

27. A method according to claim 17, supports communication method using TCP or UDP or both.

28. A method according to claim 17, the media server is a software or hardware-based telephony gateway.

29. A method according to claim 17, the signal control server manages two or more media servers, which can be in the same location or in remote geological location.
